(19) United States
(12) Patent Application Publication
(10) Pub. No.: US 2008/0264249 A1
(43) Pub. Date: Oct. 30, 2008

(54) Precipitator Energisation Control System

(75) Inventor: Rodney John Truce, Queensland (AU)

Correspondence Address: THE WEBB LAW FIRM, P.C., 700 KOPPERS BUILDING, 436 SEVENTH AVENUE, PITTSBURGH, PA, 15219, US

(73) Assignee: INDIGO TECHNOLOGIES GROUP PTY LTD, Milton (AU)

(21) Appl. No.: 12/092,243

(22) PCT Filed: Oct. 31, 2006
(86) PCT No.: PCT/AU06/01629

§ 371 Date: Apr. 30, 2008

(30) Foreign Application Priority Data
Oct. 31, 2005 (AU) 2005906016

(51) Int. Cl. B03C 3/68

(52) U.S. Cl. 95/6; 96/21

(57) ABSTRACT

The energisation of an electrostatic precipitator is controlled in order to reduce arcing and/or back corona between the precipitator electrodes, using the precipitator current as a feedback parameter. A high speed switching device is used to control the energisation of the precipitator electrodes so that the precipitator current is regulated to a desired level with a response time that is significantly less than the arc generation time constant. The energisation is controlled so that the precipitator current is regulated to a predetermined value below the current level at which arcing occurs. The energisation response is proportional to the severity of the arcing, which can be based on the power and frequency of arcing. If back corona is detected, the energisation can also be controlled to reduce back corona.

This invention relates to a control system for an electrostatic precipitator. In particular, the invention is directed to a method and apparatus for regulating the energisation of an electrostatic precipitator with the objective of maximizing the power supplied while effectively managing both arcing and back corona.

### BACKGROUND ART

[Mere reference to background art herein should not be construed as an admission that such art constitutes common general knowledge in relation to the invention.]

Electrostatic precipitators are used in many industries for the collection or removal of dust and similar particles from gas streams, such as in the cement, refinery and petrochemical, pulp and paper, and power generation industries. The operation of a precipitator involves particle charging, collection, dislodging and disposal.

The efficiency of dust collection by an electrostatic precipitator is dependent upon the electrical power and voltage, normally of negative polarity, supplied to the high voltage emitter electrodes. The dust collection efficiency will increase with increasing power until an arc occurs or until back corona (which is a localised discharge at the electrode) forms.

The collection of large dust particles (>5 um) is extremely efficient (greater than 99%) and involves two electrical processes, namely:

(1) charging the particle (which is largely dependent upon the electric field strength in the vicinity of the particle), and

(2) moving the charged particle to a grounded collector plate (which is largely dependent on the particle charge and the electric field applied to provide the force required to move the particle in a direction perpendicular to the gas flow.

The collection of the fine dust particles (<0.5 um) is not as efficient (generally about 90%), and involves a fluidic process driven by the gaseous negative ion flow from the emitter electrodes to the collector plate, normally called the ‘electric wind’. The gas flow through an electrostatic precipitator is parallel to the collector plate at a typical velocity of 1-2 m/s. The electric wind is a vastly smaller volume of gas but moves at a much higher velocity of 100-200 m/s, thus having roughly 10,000 times more kinetic energy per molecule. The electric wind is directed from the emitter electrodes to the collector plate, generally at right angles to the gas flow in the electrostatic precipitator.

The electric wind is concentrated at the corona points on the emitter electrodes, and diffuses or spreads over a larger area as it traverses the gap between the emitter electrodes and the collector plate.

Particles sized between 5 um and 0.5 um are collected by a combination of both processes with a much lower efficiency (as low as 50%). Increasing the efficiency of either process will increase the collection of particles in this size range. In particular, increasing the energisation power of the electrostatic precipitator will increase both the electric field and negative ion flow, thus assisting both the large and the fine particle collection. However, increasing energisation leads to arcing and back corona. Arcing will collapse the electric field and stop the electric wind, thus effectively stopping any dust collection. Back corona creates a reverse electric wind of opposite polarity ions flowing from the collector plate to the emitter electrodes, which discharge the already charged dust particles, thus inhibiting the large particle collection, and countering the effect of the emitter electrodes generated electric wind on the fine particles.

An arc forms when the electric field between the emitter electrodes and the collector plate is sufficient to cause direct transfer of electrons from the emitter electrodes to the grounded collector plate. The electric field is dependent upon the voltage at the emitter electrode. However, the voltage at which an arc will occur, and the intensity of the arc, are dependent on many parameters, including:
gas composition and temperature;
dust concentration, distribution and resistance;
physical state of the electrostatic precipitator including emitter electrode and collector plate arrangement and spacing; and
corona distribution and intensity, which is largely dependent upon emitter electrode shape and degree of dust build-up.

Upon the occurrence of an arc, the emitter voltage will drop rapidly and the current will spike, as illustrated in FIG. 1. Once the arcing stops, both will return relatively slowly to normal operating values. A known method for detecting arcs is to monitor the electrostatic precipitator voltage and/or current for one of the following events which occur during an arc:

(i) a large and rapid rise in the electrostatic precipitator current, using a rate of change monitor;

(ii) a large and rapid fall in the electrostatic precipitator voltage, using a rate of change monitor;

(iii) a fall in the electrostatic precipitator voltage to a level below a set minimum value and/or an increase in electrostatic precipitator current to a level above a set maximum value.

A known method for controlling arcing is to reduce the energisation power to cause the arc to dissipate. This normally involves turning the power off completely for a short period, usually termed de-ionisation, and/or simply reducing the energisation power by a fixed amount, usually termed ‘step-back’. This process is called ‘arc quenching’, since the aim is to stop or quench the arc. The energisation power is then increased at a set rate, usually termed the ‘ramp-rate’, until another arc occurs. By adjusting the level of the step-back and the ramp-rate, the frequency of arcing can be controlled. This process reduces the average energisation power available to collect dust, since the energisation power is continually stepping back then ramping up, and actually induces a large number of arcs, due to the ramp exceeding the arc level.

Back corona is a breakdown of the gas within the collected dust layer on the collector plate, which is caused by a high electric field induced by the electric wind charge flowing through the highly resistive dust layer to the grounded collector plate. Negative ions emitted by the emitter electrode(s) or corona wire travel to the dust layer where they are not discharged owing to the resistivity of the dust. As a result, charge builds up to the point where gas molecules trapped in the dust layer are ionised creating positive ions that travel back to the corona wire. As shown schematically in FIG. 2, this process produces positive ions that move from the collector plate dust layer through the gas to the emitter electrode(s) or corona wire. This is the reverse of the electric wind generated by the negative ion flow from the emitter electrode(s) or corona wire, and can be considered a reverse electric wind.

Because the reverse electric wind generated by back corona is composed of positive ions, any dust with a negative charge will be discharged. Thus the reverse electric wind undoes or negates the charging process that is necessary to collect large particles. In fact, it can charge duct particles with a positive charge and cause them to move towards and even attach to the emitter electrodes. Severe emitter electrodes dust build-up, which causes severe loss of energisation power, is a common occurrence on an electrostatic precipitator operating with back corona.

The fine particle collection will also be reduced by the reverse electric wind, due to the equally high velocity of the positive ions moving towards the emitter electrodes. Thus, for maximum dust collection in the electrostatic precipitator, it is important that back corona be detected and controlled.

It is an aim of this invention to overcome or ameliorate the disadvantages described above by providing an improved method and apparatus for regulating the energisation of an electrostatic precipitator with the objective of maximizing the power supplied while effectively managing both arcing and back corona.

### SUMMARY OF THE INVENTION

In one broad form, the invention provides a method of controlling energisation of a electrostatic precipitator to reduce arc generation and/or back corona. The method comprises the steps of

(i) monitoring current operatively passing between the precipitator electrodes to detect arcing between the electrodes; and

(ii) controlling energisation of the electrostatic precipitator using a high speed switching circuit with a response time that is substantially less than the arc generation time constant.

(The arc generation time constant is the time required for the arc to develop to a predetermined level, typically approximately 63 percent of its final amplitude.)

In a preferred embodiment, the electrostatic precipitator current is used as feedback to control the electrostatic precipitator power with a rapid response (typically less than about 30 μS, and preferably in the order of 10 μS) through use of a high speed solid state switch. By such rapid control of the electrostatic precipitator power, the effect of arcs on electrostatic precipitator electrical conditions is minimised.

Typically step (i) includes determining the level of precipitator current at which arcing occurs; and step (ii) includes adjusting the energisation of the electrostatic precipitator such that the precipitator current is at a predetermined value below the level at which arcing occurs.

By automatically adjusting the electrostatic precipitator power so that the electrostatic precipitator operates just below the arc voltage, the electrostatic precipitator will be operating at the optimum power level. That is, in the absence of both arcing and back corona, the electrostatic precipitator dust collection will increase with increasing energisation power. By maintaining the energisation power at a point just below that which would cause either arcing or back corona, the electrostatic precipitator dust collection will be maximised.

Preferably, step (i) includes determining the severity of the arcing based on the power and frequency of the arcing; and step (ii) includes controlling energisation of the electrostatic precipitator with a degree of response proportional to the arc severity. For example, the energisation of the electrostatic precipitator need not be reduced unless the arc severity is above a predetermined power level and either (a) the arcing is sustained for a predetermined period or (b) the arcing is repeated within the predetermined period.

By responding accordingly to arcing, e.g. by limiting the arc response for low severity and random arcs and increasing the arc quench as the rate of sparking increases, the power reduction due to arc quenching will be minimised.

In one embodiment, step (ii) includes initially reducing the energisation of the electrostatic precipitator by a small decrement, then rapidly increasing the energisation of the electrostatic precipitator back to its original level at a predetermined ramp rate, and if arcing continues, repeating the two preceding steps while varying the decrement and the ramp rate depending upon the rate of arcing. If arcing continues at more than 10 arcs per seconds, the decrement is increased and/or the ramp rate is reduced; if arcing continues at between 10 and 20 arcs per seconds, the decrement is increased and/or the ramp rate is reduced; and the energisation of the electrostatic precipitator increased to a level below its original level; and if arcing continues at more than 20 arcs per seconds, the electrostatic precipitator is temporality de-energised, the decrement is increased and/or the ramp rate is reduced, and the energisation of the electrostatic precipitator is increased to a level below its original level.

Preferably, the method further comprises the step of detecting back corona in the electrostatic precipitator, and step (ii) includes adjusting the energisation of the electrostatic precipitator to reduce back corona.

For example, the method may comprise the steps of

(a) detecting the presence of back corona between the electrodes, and if back corona is present, reducing the energisation by a predetermined decrement to reduce the precipitator current below the level at which back corona starts, or

(b) measuring the peak voltage between the electrodes of the electrostatic precipitator, and increasing the current set-point by a predetermined increment,

and

if neither back corona nor arcing is detected within a predetermined period thereafter, repeating steps (a) and (b), or, if either back corona or arcing is detected within the predetermined period, adjusting the energisation of the electrostatic precipitator by an offset.

In another broad form, the invention provides apparatus for controlling an electrostatic precipitator having electrodes of opposite polarity, the apparatus comprising

a switched power supply for energising the electrodes,

means for monitoring the current operatively passing between the electrodes and/or the voltage between the electrodes to detect arcing and/or back corona between the electrodes, and

an electrical controller, responsive to the detection of arcing and/or back corona between the electrodes, for controlling the switched power supply to thereby vary the energisation of the electrostatic precipitator,

wherein the switched power supply is controlled with a response time that is substantially less than the arc generation time constant.

Typically, the switched power supply includes a high speed solid state switch to is control the energisation of the electrostatic precipitator.

In order that the invention may be more readily understood and put into practice, one or more preferred embodiments thereof will now be described, by way of example only, with reference to the accompanying drawings.

### BRIEF DESCRIPTION OF THE DRAWINGS

FIG. 1 illustrates electrode voltage and current behaviour during the occurrence of an arc.

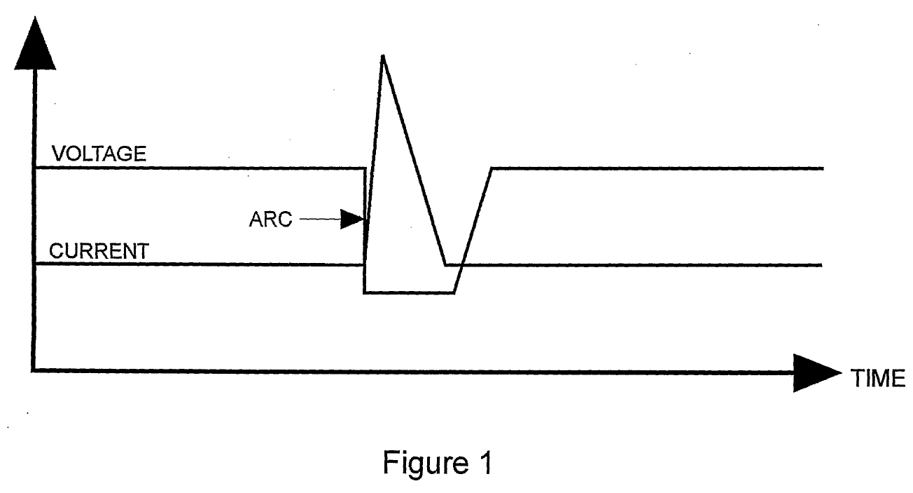

FIG. 2 is a fragmentary sectional view of a collector plate illustrating ion flow during back corona.

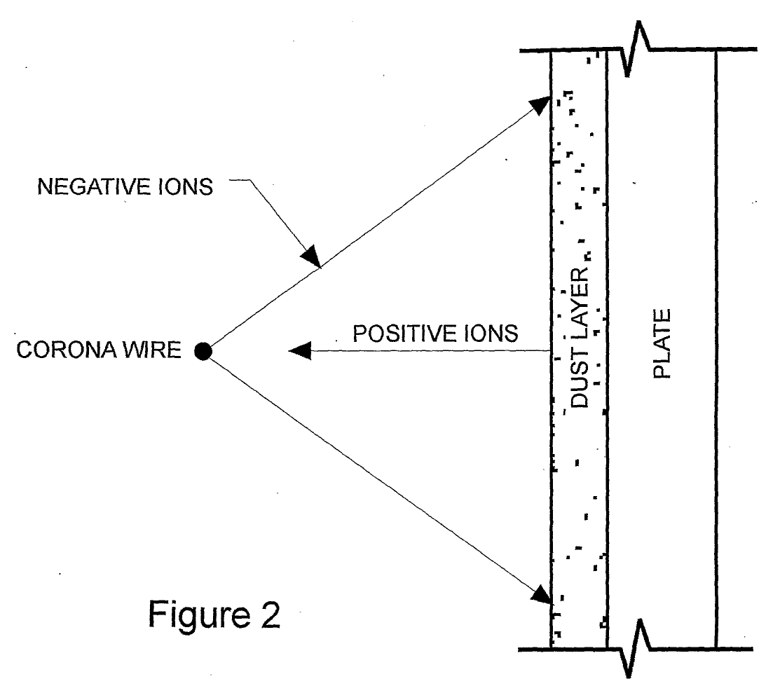

FIG. 3 is a general circuit diagram of a conventional energisation circuit for an electrostatic precipitator.

FIG. 4 is a general circuit diagram of one embodiment of this invention.

FIG. 5 illustrates electrode voltage during an arc control process used in the embodiment of FIG. 4.

FIG. 6 illustrates electrode voltage during back corona occurrence.

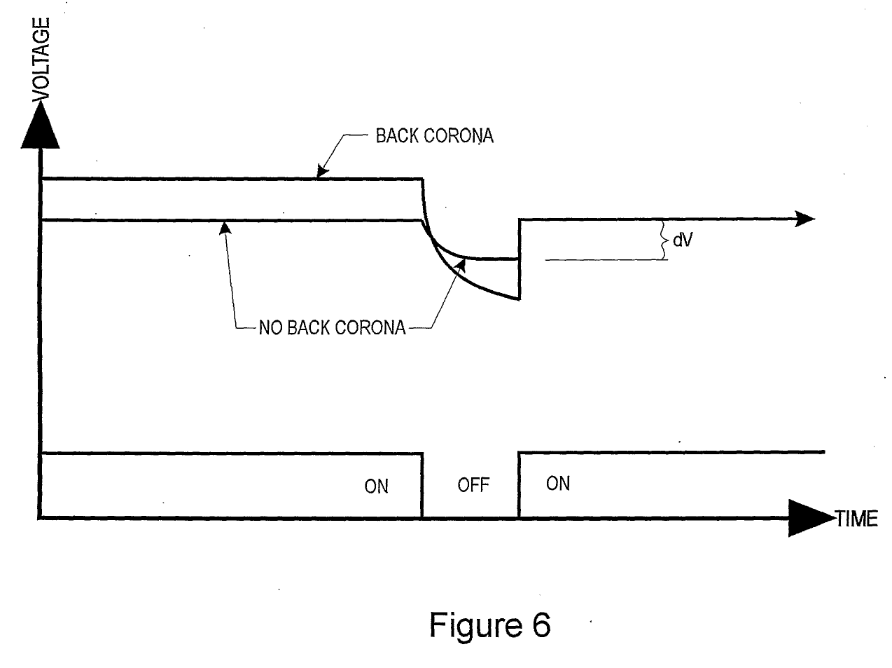

FIG. 7 illustrates back corona detection using the voltage waveform characteristics.

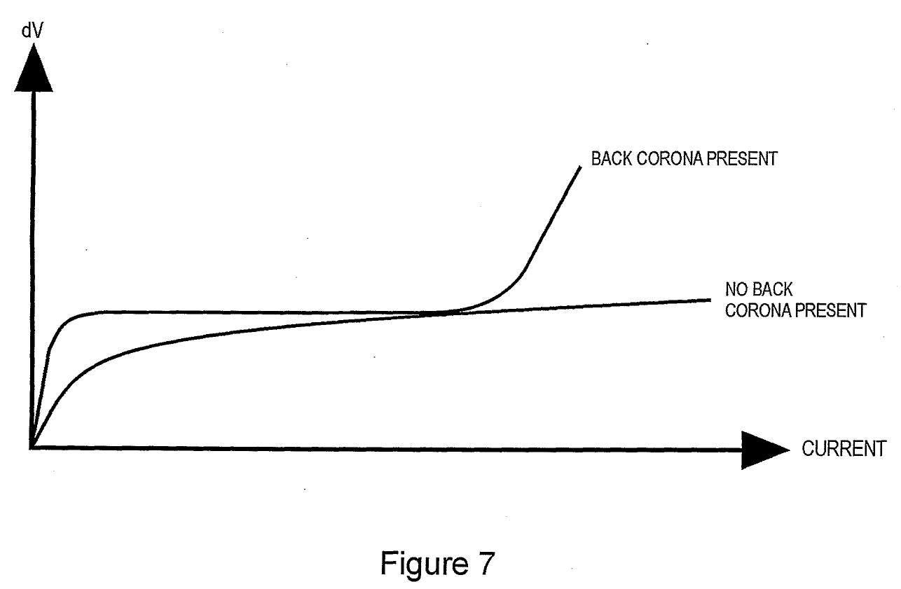

### DESCRIPTION OF THE PREFERRED EMBODIMENT

The electrostatic precipitator energisation control system of the preferred embodiment involves four principal functions or components, namely:

(1) high speed regulation of the energisation power to control the current flowing in the electrostatic precipitator to a set level;

(2) adjusting the desired current set-point to a level so as to maintain the electrostatic precipitator voltage just below that required for an arc to form;

(3) detecting and reacting to arcs so as to minimize the reduction in energisation power while still preventing excessive arcing;

(4) detecting and limiting the level of back corona occurring in the electrostatic precipitator to optimize the level electric wind and reverse electric wind. These are discussed in detail below.

### (1) Energisation Power Regulation

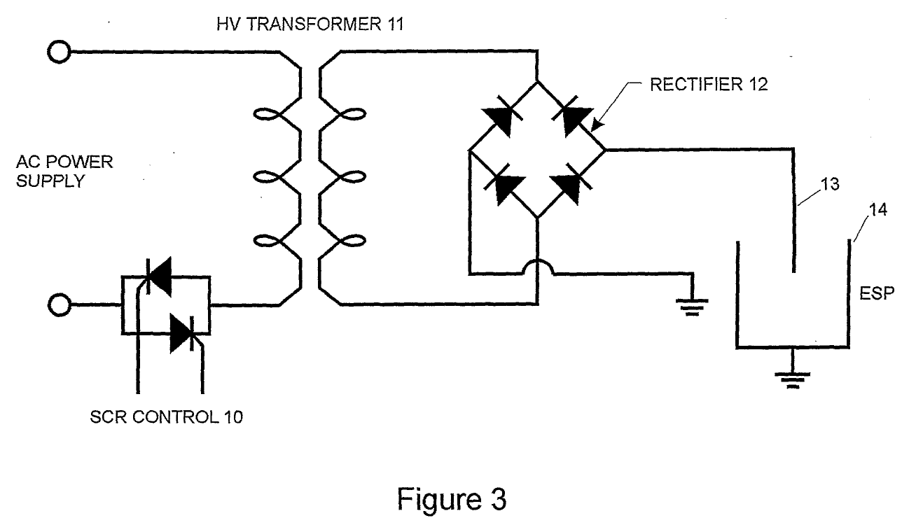

As shown in FIG. 3, a conventional electrostatic precipitator energisation system uses a silicon controlled rectifier (SCR) switch 10 to control the AC power supplied to a transformer 11 that raises the voltage to the 40-60 kV typically required. The high voltage AC output from the transformer 11 is rectified by rectifier 12. The negative output of the rectifier is connected to the emitter electrodes 13 of an electrostatic precipitator (“ESP”), while its positive output is connected through ground to the collector plates 14 of the ESP. However, this type of circuit limits the energisation power response since, once turned on, the SCR will not turn off until the AC supply passes through zero voltage.

Modern solid-state power switches, such as the gate turn-off thyristors or high power MOSFETs, can be turned on and off rapidly at any time. This has enabled the development of switch-mode electrostatic precipitator energisation systems that can operate at high voltage and provide the high energisation power required.

Solid-state switch technology allows very rapid control of the energisation power, in the order of microseconds compared to milliseconds for the traditional system. This rapid energisation power response enables the regulation of the electrostatic precipitator current in accordance with the present invention.

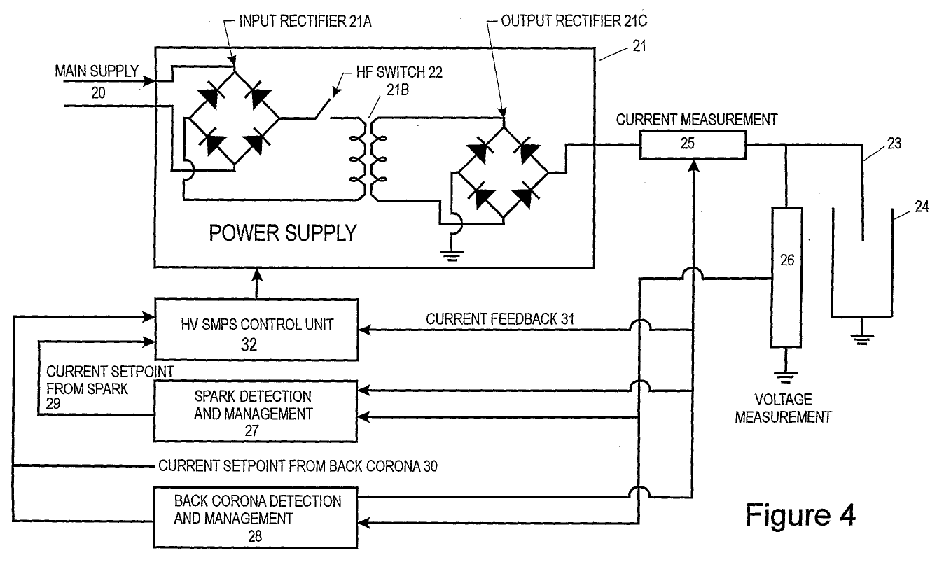

A block diagram of the apparatus of a preferred embodiment of this invention is shown in FIG. 4. A high voltage AC power supply 20 is connected to a solid state rectifier 21 which comprises an input rectifier 21A, an output rectifier 21C, and a transformer 21B. The negative output of the input rectifier 21A is connected, via a high frequency switch 22, to the transformer 21B. The output of the transformer 21B is connected to output rectifier 21C whose negative output is connected to emitter electrodes 23 of an ESP, and whose positive output is connected through ground to collector plates 14 of the ESP.

The electrode current is monitored by a suitable current measurement device 25, and the emitter voltage is monitored by a suitable voltage measurement device 26. The outputs of the current and voltage measurement devices 25, 26 are connected to a control unit 32 which controls the switch 22 in the high voltage power supply rectifier 21. Through the switch 22, the control unit 32 is able to effect high speed switching of the power supply.

The outputs of the current and voltage measurement devices 25,26 are also connected to both a spark detection and management circuit 27 and a back corona detection and management circuit 28. The outputs of the spark detection and management circuit 27 and the back corona detection and management circuit 28 are fed to control unit 32 and used to control the power supply, and in particular, the high frequency switch 22.

At the onset of an arc, the electrostatic precipitator current will rise rapidly, in the order of several tens of microseconds. This current spike is detected by the spark detection and management circuit 27, which causes the control circuit 32 to reduce the energisation power rapidly to quench and control the arc. This can be achieved by the control unit 32 turning off the energy supply via switch 22 for a very short time, by reducing the voltage and/or current supplied to the primary of the transformer used to generate the high voltage used in the electrostatic precipitator or, in the case of a switch mode power supply, the frequency and/or the on-off ratio of the switched primary supply to the transformer used to generate the high voltage used in the electrostatic precipitator can be changed.

The arc generation time constant is typically around 50 μS. The switching of the high speed switch should therefore be faster than 30 kHz (resulting in a switching interval of less than 33 μS). A switching interval of about 10 μS is preferred.

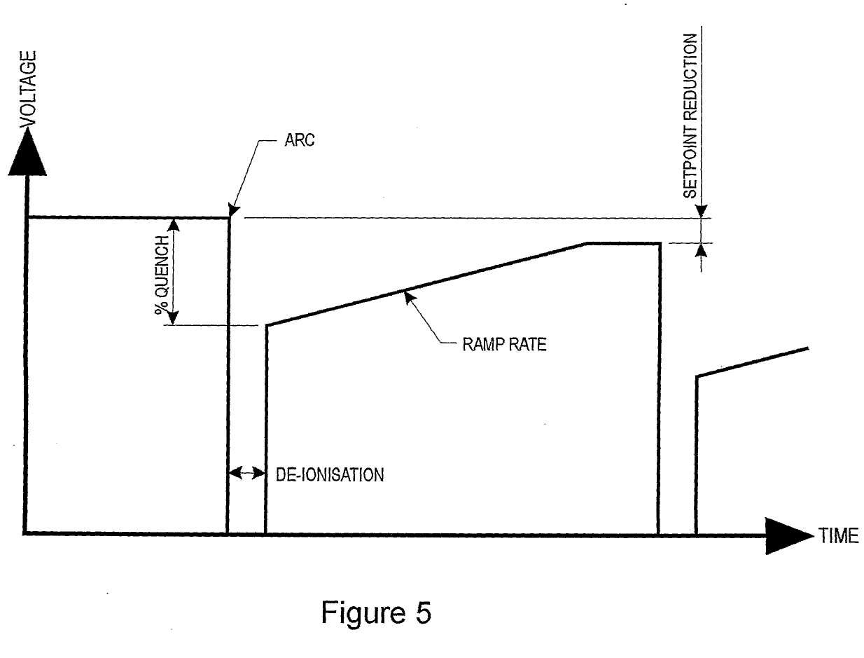

Once the electrostatic precipitator current drops back below a desired set-point, set by current setpoint input 29, the energisation power can be increased to maintain the electrostatic precipitator current at the desired level, as depicted in FIG. 5. This method of energisation power regulation limits the arc intensity should an arc occur, thereby minimising the impact on the electrostatic precipitator performance. The regulation can be performed using a traditional negative feedback control system incorporating a PID or similar algorithm.

Conventional ESP switch mode power supplies do not control precipitator current; rather they control the voltage, letting the current be determined by physics. When an arc forms, the current increases and the voltage drops. The conventional controller then turns the switched power supply off, waits a few cycles and then ramps the power back up slowly. On the other hand the control system of the illustrated embodiment monitors the precipitator current. Consequently, as an arc begins to form, the rapid increase in current is detected, and then quickly limited by the rapid switching of the switched power supply. The control system aims to quench the arc before it occurs. This means that arcs are cut off much faster, and recovery is much sooner than achieved with conventional switch mode power supplies.

### 2. Electrostatic Precipitator Current Set-Point Adjustment

The desired current set-point 29 for the electrostatic precipitator is set by either the spark detection and management circuit 27 or the back corona detection and management circuit 28.

The optimum current set-point is determined as follows:

(i) If the back corona control is active, the present current set-point is reduced by a set amount, generally but not necessarily a percentage of the present current set-point. This reduces the electrostatic precipitator current below that level at which back corona starts. Back corona control is active if the back corona detection 28 is enabled and back corona was detected during previous set-point adjustment. If back corona control is not active, the present current set-point should not be reduced.

(ii) Next, the electrostatic precipitator peak voltage should be measured, the current set-point should then be increased by a set amount and, if the back corona control is active, the back corona detection system 28 should be activated.

(iii) If, after a set period, neither back corona nor an arc is detected, Steps (i) and (ii) should be repeated. If one or more arcs are detected, the optimization arc count should be increased by the number of arcs detected. If the optimization arc count exceeds a set number or back corona is detected, the process should proceed to Step (iv).

(iv) If back corona is detected, the previous current set-point, adjusted by a back corona set offset, should be used as the desired current set-point. If the total number of arcs exceeds the optimization arc count, the previous current set-point, adjusted by a set arc offset, should be used as the desired current set-point or, if desired, the previous electrostatic precipitator peak voltage, adjusted by a set arc offset, should be used as a set-point and the desired current set-point adjusted periodically, at about one second intervals, to maintain the electrostatic precipitator peak voltage at this level.

This process should be performed at regular set intervals, generally of the order of 10 to 30 minutes.

### 3. Arc Detection and Quench

As mentioned above, when an arc starts, the first change in the electrostatic precipitator conditions is an increase in the electrostatic precipitator current. The control system, described above, will immediately respond by reducing the power supplied to electrostatic precipitator. By monitoring the control system, an arc can be detected when one or both of the following occur:
the regulation system reduces the power at a rate in excess of a set rate.
the regulation system reduces the power to a level below a set level.

The severity of the arc can be determined by monitoring either the rate of power reduction or the level of the reduction. These parameters can also be used in conjunction with the electrostatic precipitator current and voltage measurements to further refine the arc severity measurement. As the arc severity increases, the electrostatic precipitator current will rise to a higher level and the electrostatic precipitator voltage will fall to a lower level.

The traditional response to an arc is, as described in the Background Art section above, to reduce or turn off the energy supply to the electrostatic precipitator, called ‘arc quenching’. Random arcs, which self quench, will occur in the electrostatic precipitator from time to time, for instance during rapping. In such cases the arc quench process is a waste of energy. It is proposed that no arc quenching take place unless the arc severity is above a set level and one of the following occurs:
the arc is sustained for an extended period, say 10 milliseconds.
the arc is repeated within a short interval, again say 10 milliseconds.

Initially, the arc quench should be limited, say a small (10%) step down in power then a rapid ramp back to the original electrostatic precipitator current level. If the arcs continue, this arc quench response should be increased dependent upon the rate of arcing, measured in terms of arcs/second (a/s). For example:

(i) If the arc rate exceeds 10 a/s, the step down in power could be increased and/or the ramp rate reduced.

(ii) If the arc rate exceeds 20 a/s, the step down in power could be increased again and/or the ramp rate further reduced plus the desired electrostatic precipitator current could be reduced.

(iii) If the arc rate exceeds 20 a/s, the power could be turned off for a short period, called ‘de-ionization’, the step down in power could be increased again and/or the ramp rate further reduced plus the desired electrostatic precipitator current could be reduced more.

It is possible to have many more steps than described above and it is possible to vary the parameters, such as level of step down in power, ramp rate, electrostatic precipitator current set-point reduction and de-ionization interval, with arc rate so as to proportionally increase the arc quench response. This will result in considerably less power being wasted in quenching arcs that would otherwise self quench.

### 4. Back Corona Detection and Control

When back corona forms in the collected dust layer on the collector plate, the positive ions generated by the back corona will increase the rate of current flow in the electrostatic precipitator, which will result in a reduction in the electrostatic precipitator voltage if the electrostatic precipitator current is held constant. The electrostatic precipitator voltage will decrease by the amount required to reduce the emitter corona so that the number of negative ions generated is reduced by an amount equal to the number of positive ions generated by the back corona. Thus, if back corona is present and the electrostatic precipitator current is increased in a step, the electrostatic precipitator voltage will increase followed by a decrease as back corona develops causing an increase in the positive ion flow.

One method for detecting back corona is to monitor the electrostatic precipitator minimum voltage, which is the minimum level of any AC ripple on the negative DC voltage, then increase the electrostatic precipitator current by a set step change. The electrostatic precipitator voltage will initially increase, but, if this increase is followed by a subsequent decrease, back corona is present. The level of the subsequent decrease is an indication of the severity of the back corona. Depending upon which section of the electrostatic precipitator is being controlled, the optimum electrostatic precipitator performance may be above back corona onset. The severity of back corona that is acceptable may be set by defining a level of subsequent electrostatic precipitator minimum voltage decrease that is acceptable for a set current step. The electrostatic precipitator current can therefore be increased in controlled steps until the required level of subsequent electrostatic precipitator minimum voltage decrease is detected. The electrostatic precipitator current can then be regulated to this desired level by the control system.

A second method for detecting back corona is to turn off the energy supply to the electrostatic precipitator for a fixed period of time sufficient for the electrostatic precipitator emitter corona to cease, for say 5 to 10 milliseconds, and monitor the subsequent electrostatic precipitator minimum voltage decrease. Because the electrostatic precipitator acts as a capacitor, the voltage will decrease exponentially with time at a rate dependent upon the ion flow. Because of the time required for the ions to flow across the gap between the emitter electrodes and the collector plate is about 1 millisecond and the back corona will not cease until the negative emitter ion flow at the collector plate has ceased, the positive back corona ion flow will continue for 1 to 2 milliseconds after the emitter ion flow ceases. This will result in an additional discharge of the electrostatic precipitator and a subsequent reduction in the electrostatic precipitator voltage.

By carrying out this test at a current level below back corona onset, the minimum level that the electrostatic precipitator voltage will fall in a fixed period of time can be measured. The electrostatic precipitator current can then be increased and the test repeated. If the minimum level that the electrostatic precipitator voltage falls in the same fixed period of time gets lower, back corona is present. Again the amount of the subsequent decrease in the minimum level that the electrostatic precipitator voltage falls beyond that measured for the no back corona condition is an indication of the severity of the back corona. Depending upon which section of the electrostatic precipitator is being controlled, the optimum electrostatic precipitator performance may be above back corona onset. The severity of back corona that is acceptable may be set by defining a level of subsequent electrostatic precipitator minimum voltage decrease that is acceptable. Thus the electrostatic precipitator current can be increased and this test repeated until the decrease electrostatic precipitator minimum voltage detected is equal to that required for the required level of back corona. The electrostatic precipitator current can then be regulated to this desired level by the control system.

By controlling the electrostatic precipitator power to regulate electrostatic precipitator current with a rapid response (in the order of 10 us), the effect of arcs on electrostatic precipitator electrical conditions is minimised. By adjusting the electrostatic precipitator power so that the electrostatic precipitator operates just below the arc voltage or at or above the back corona onset current, the electrostatic precipitator will be operating at the optimum power level. By limiting the arc response for low severity and random arcs then increasing the arc quench as the rate of sparking increases, the power reduction due to arc quenching will be minimized. All of these processes will improve electrostatic precipitator performance.

The control system described above can be implemented using a switch mode power supply or a high speed solid state switch to control the primary power supply to the electrostatic precipitator. Magnetic devices, such as flux density controlled transformers, can also be used.

The foregoing description is illustrative only of the principles of the invention, and various modifications and changes will readily occur to those skilled in the art. The invention is capable of being practised and carried out in various ways and in other embodiments. It is also to be understood that the terminology employed herein is for the purpose of description and should not be regarded as limiting.

Accordingly, it is to be understood that the scope of the invention is not to be limited to the exact construction and operation described and illustrated, but only by the following claims which are intended, where the applicable law permits, to include all suitable modifications and equivalents within the spirit and concept of the invention.

Throughout this specification, including the claims, where the context permits, the term “comprise” and variants thereof such as “comprises” or “comprising” are to be interpreted as including the stated integer or integers without necessarily excluding any other integers.

1. An electrostatic precipitator having a precipitator current operatively passing between electrodes, a method of controlling energisation of the electrostatic precipitator to reduce arc generation and/or back corona between the electrodes, comprising the steps of:
(i) monitoring said current to detect arcing between the electrodes; and
(ii) controlling energisation of the electrostatic precipitator using a high speed switching circuit with a response time that is substantially less than the arc generation time constant.

2. The method as claimed in claim 1, wherein:
step (i) includes determining the level of precipitator current at which arcing occurs; and
step (ii) includes adjusting the energisation of the electrostatic precipitator such that the precipitator current is at a predetermined value below the level at which arcing occurs.

3. The method as claimed in claim 1, wherein:
step (i) includes determining the severity of the arcing based on the power and frequency of the arcing; and
step (ii) includes controlling energisation of the electrostatic precipitator with a degree of response proportional to the arc severity.

4. The method as claimed in claim 3, wherein energisation of the electrostatic precipitator is not reduced unless the arc severity is above a predetermined power level and either (a) the arcing is sustained for a predetermined period, or (b) the arcing is repeated within the predetermined period.

5. The method as claimed in claim 3, wherein step (ii) includes:
initially reducing the energisation of the electrostatic precipitator by a small decrement,
then rapidly increasing the energisation of the electrostatic precipitator back to its original level at a predetermined ramp rate, and
if arcing continues, repeating the two preceding steps while varying the decrement and the ramp rate depending upon the rate of arcing.

6. The method as claimed in claim 5, wherein:
if arcing continues at more than 10 arcs per seconds, the decrement is increased and/or the ramp rate is reduced;
if arcing continues at between 10 and 20 arcs per seconds, the decrement is increased and/or the ramp rate is reduced; and the energisation of the electrostatic precipitator is increased to a level below its original level; and
if arcing continues at more than 20 arcs per seconds, the electrostatic precipitator is temporarily de-energised, the decrement is increased and/or the ramp rate is reduced, and the energisation of the electrostatic precipitator is increased to a level below its original level.

7. The method as claimed in claim 2, further comprising the step of detecting back corona in the electrostatic precipitator, and wherein step (ii) includes adjusting the energisation of the electrostatic precipitator to reduce back corona.

8. The method as claimed in claim 7 comprising:
(a) detecting the presence of back corona between the electrodes, and if back corona is present, reducing the energisation by a predetermined decrement to reduce the precipitator current below the level at which back corona starts, or
(b) measuring the peak voltage between the electrodes of the electrostatic precipitator, and increasing the current set-point by a predetermined increment,
and
if neither back corona nor arcing is detected within a predetermined period thereafter, repeating steps (a) and (b), or, if either back corona or arcing is detected within the predetermined period, adjusting the energisation of the electrostatic precipitator by an offset.

9. An apparatus for controlling an electrostatic precipitator having electrodes of opposite polarity, the apparatus comprising:
a switched power supply for energising the electrodes,
means for monitoring the current operatively passing between the electrodes and/or the voltage between the electrodes to detect arcing and/or back corona between the electrodes, and
an electrical controller, responsive to the detection of arcing and/or back corona between the electrodes, for controlling the switched power supply to thereby vary the energisation of the electrostatic precipitator,
wherein the switched power supply is controlled with a response time that is substantially less than the arc generation time constant.

10. The apparatus as claimed in claim 9, wherein the switched power supply includes a high speed solid state switch to control the energisation of the electrostatic precipitator.

11. The method as claimed in claim 4, further comprising the step of detecting back corona in the electrostatic precipitator, and wherein step (ii) includes adjusting the energisation of the electrostatic precipitator to reduce back corona.

12. The method as claimed in claim 11, comprising:
(a) detecting the presence of hack corona between the electrodes, and if back corona is present, reducing the energisation by a predetermined decrement to reduce the precipitator current below the level at which back corona starts, or
(b) measuring the peak voltage between the electrodes of the electrostatic precipitator, and increasing the current set-point by a predetermined increment,
and
if neither back corona nor arcing is detected within a predetermined period thereafter, repeating steps (a) and (b), or, if either back corona or arcing is detected within the predetermined period, adjusting the energisation of the electrostatic precipitator by an offset.

13. The method as claimed in claim 6, further comprising the step of detecting back corona in the electrostatic precipitator, and wherein step (ii) includes adjusting the energisation of the electrostatic precipitator to reduce back corona.

14. The method as claimed in claim 13, comprising:
(a) detecting the presence of back corona between the electrodes, and if back corona is present, reducing the energisation by a predetermined decrement to reduce the precipitator current below the level at which back corona starts, or
(b) measuring the peak voltage between the electrodes of the electrostatic precipitator, and increasing the current set-point by a predetermined increment,
and
if neither back corona nor arcing is detected within a predetermined period thereafter, repeating steps (a) and (b), or, if either back corona or arcing is detected within the predetermined period, adjusting the energisation of the electrostatic precipitator by an offset.
